(19) United States
(12) Patent Application Publication
(10) Pub. No.: US 2007/0206586 A1
(43) Pub. Date: Sep. 6, 2007

(54) Method, mobile device, system and software for flexible burst length control

(76) Inventors: Matti Floman, Kangasala (FI); Jani Klint, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/713,539

(22) Filed: Mar. 2, 2007

Related U.S. Application Data
(60) Provisional application No. 60/779,269, filed on Mar. 2, 2006.

(51) Int. Cl. H04L 12/50

(52) U.S. Cl. 370/378

(57) ABSTRACT

A method, apparatus, system, and software product are presented for stopping a continuous burst, or a maximum supported burst, that is used to read from or write to a memory. An indication is provided to release a data bus. Subsequently, the data bus is released in response to the indication, but only after a lapse of time that substantially eliminates unneeded data cycles.

### CROSS-REFERENCE TO RELATED APPLICATION

The present application claims priority to U.S. Provisional Application 60/779,269 filed Mar. 2, 2006.

### FIELD OF THE INVENTION

The invention relates to memories, and more particularly relates to transferring information to a memory via a memory interface.

### BACKGROUND OF THE INVENTION

Computer memories have normally been designed to use one memory device for each bit, or for each small group of bits, of any individual computer word. The word size is governed by the choice of computer, and word sizes typically have ranged from 4 to 64 bits. Thus, each memory device is usually connected to one of a series of data lines. One or more devices may be connected to each data line, but typically only a small number of data lines are connected to a single memory device. Data is thus accessed (i.e. read) or provided (i.e. written) in parallel, for each memory read or write operation, respectively.

Different memory access techniques use various burst lengths for providing optimum performance of each application. For example, graphics require short bursts, whereas cache-filling uses long bursts. However, if only short or long bursts are used, then power and performance are necessarily lost.

The RAMBUS company has defined a method which defines burst length at the same time as burst access is performed. The RAMBUS method is limited to predefined burst lengths having multiples of 2. A pair of RAMBUS patents are incorporated herein by reference: Farmwald I (U.S. Pat. No. 6,032,214), and Farmwald II (U.S. Pat. No. 6,034,918). Incidentally, those two patents refer to the burst length as “block size.”

It is well known that memory can have a predefined burst length, which is typically a multiple of 2 (e.g. 2, 4, 8 or 16), as in the aforementioned RAMBUS patents. If a memory bus executes fast, then it is important to give the memory a maximum time to fetch the right amount of data for optimum performance and power consumption. A known way to do this is to select, from certain fixed values, one particular value that will be used during a burst, before making burst access, or while burst access is performed (as in Farmwald I and II).

It is also known to have a continuous burst without limit, and to stop this kind of continuous burst with a command in a command bus. According to such a method, a burst stop (BST) command is given when it is desired to stop the burst. Unfortunately, that method causes empty clocks regarding the data bus, at least in case of Dynamic Random Access Memory (DRAM) busses. A continuous burst stop is described, for example, in a document from MICRON TECHNOLOGY, INC. titled “Mobile Double Data Rate (DDR) SDRAM,” which is also incorporated herein by reference. The MICRON document refers to a continuous burst stop as a “burst terminate (BST)”.

Data mask signaling is often used in case of a write operation, and has also been used for read operations in a DRAM environment. The status of a data mask pair indicates whether data on the bus is valid or should instead be ignored. Unfortunately, that method does not remove invalid data from the bus, and leaving invalid data in the bus causes the problem that data bus cycles are lost.

### SUMMARY OF THE INVENTION

The present invention is related to earlier applications in the Third Generation Mobile System, but provides a new way to have flexible burst length in a memory bus, such as the new fast execution bus of the Joint Electronic Devices Engineering Council (JEDEC). This same new method can be used in conjunction with any memory type (DRAM/NOR/mass memory) that is connected to a similar interface.

According to this invention, the memory will always use a continuous burst or maximum supported burst length (which can be stopped). The method of the present invention is especially useful for allowing flexible burst length with a fast memory interface.

Thus, an unspecified burst length can be used until the burst is stopped, or alternatively a maximum burst length could be used (e.g. 16) but is stopped in case of a shorter burst. The stop method can be accomplished, for example, by reusing data mask signals to indicate when data is supposed to be stopped

This method defines a new way for allowing scalable burst lengths. Although this method is based on known continuous burst features, this invention defines a new way to stop the burst in a manner that is optimized for fast interfaces. It is assumed that burst access is not connected to burst length or maximum supported burst length (until the burst is stopped). Instead, several implementations are defined that provide information as to the amount of needed data so that empty data bus cycles do not emerge, and so that memory does not spend power internally seeking unused bits.

It is believed that this manner of stopping a burst is compatible with existing methods like the RAMBUS method. Because the present invention is based upon a continuous burst or maximum supported burst length, the invention is not limited to any predefined value, even though multiples of 2 are typically preferred.

There are several major advantages of this invention, including optimization of power and performance. The performance benefit comes also from improved data mask (DM) operations. In other words, during the write operation, no useless data cycles are needed.

Moreover, the invention requires no additional pins. And, all of this is accomplished without losing any command cycles, in case of a signal-based or calculation-based implementation.

### BRIEF DESCRIPTION OF THE DRAWINGS

FIG. 1 illustrates timings for a signal-based method according to the present invention.

FIG. 2 is a flow chart showing a method according to one embodiment of the present invention.

FIG. 3 is a block diagram according to an embodiment of the present invention.

### DETAILED DESCRIPTION OF THE INVENTION

The present invention will now be further explained in terms of four related implementations of a method for burst length control. Each of these four implementations attains the same principle functionality.

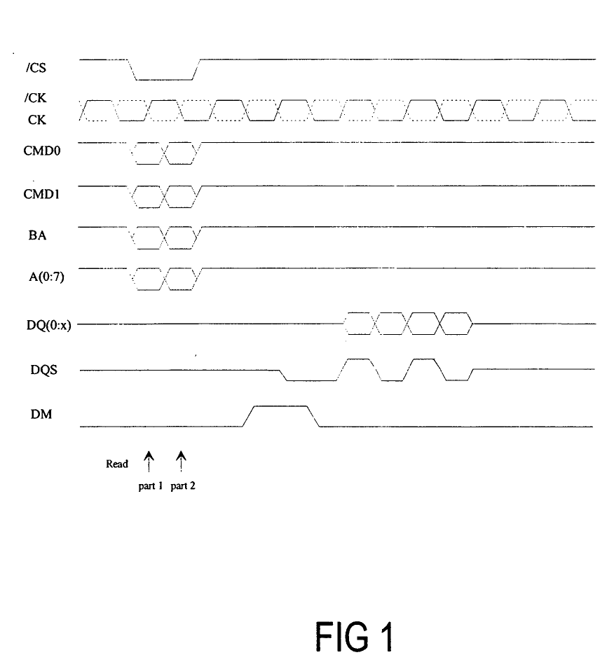

The first of the four implementations is a signal-based method. In an optimized controller, one of the data mask signals (or alternatively some other additional/existing signal) is used to indicate to the memory a time of column address strobe (tCAS) before which the data bus must be released. The tCAS indicates the time (e.g. number of clock cycles) needed to access valid data on the data bus. However, the tCAS time is a minimum, and in some cases it makes sense to have available a longer duration for providing more time for the memory to act. In case of very fast buses and over-optimized performance, it can be useful to provide an additional write burst stop with read or write, since it is possible to have a timing conflict for usage of the mask signal in this case, or power/performance might be lost because of a stop indication that is too late (e.g. memory is already started next fetching). FIG. 1 shows timings for a signal-based method.

The second of the four implementations is a register-based method. This method could be understood as advanced burst stop, used already in DRAMs. The novelty of this implementation resides in predefining the time, once a stop indication arrives, and a register for storing this time is needed. The way to indicate a burst stop can be either a command, or a register write, or even a signal.

The third of the four implementations is a calculation-based implementation. In this method, the memory has a capability to recognize when a counter starts (i.e. some command starts the counter), and to recognize when the counter stops due to commands or addresses. This counter value would then indicate how many data cycles are needed. For example, an indication of a start could be a row address which comes with a row activate command and a finishing column address which comes with a read or write command, or in case of column-only then a column address could be split into two or even more cycles. The challenge for this method is that for different burst lengths there would be different times, e.g. in case of address; counter start and stop commands time interval is predefined by the needed burst length, therefore making the bus usage more complicated It should be noted that a counter can also be stopped by a signal, in addition to a command.

The fourth of the four implementations is an enhanced signal-based method. In an optimized controller, one of the data mask signals (or alternatively some other additional/existing signal) is used to indicate to the memory a time which defines when the data bus must be released. In this implementation, the memory calculates rising clock edges from a read/write command (falling edges could be used as well but then of course the formula is different). The result of this calculation is then used in a formula, such as 2 to the power of sum, or 2 times the sum. This formula could be used also with the calculation-based implementation. According to that formula, if a burst length of 8 is desired, for instance, then 3 rising edges would be provided. This method could be enhanced: e.g. the calculation could start from 2, 4 or something else. In case of starting from 2, one calculated rising edge would result in a burst length of four. This implementation gives the longest time for the memory to behave properly. Among these four implementations, the signal-based methods are likely to provide the best implementation, especially if it is a data-mask signal-based implementation in a case like the DRAM case.

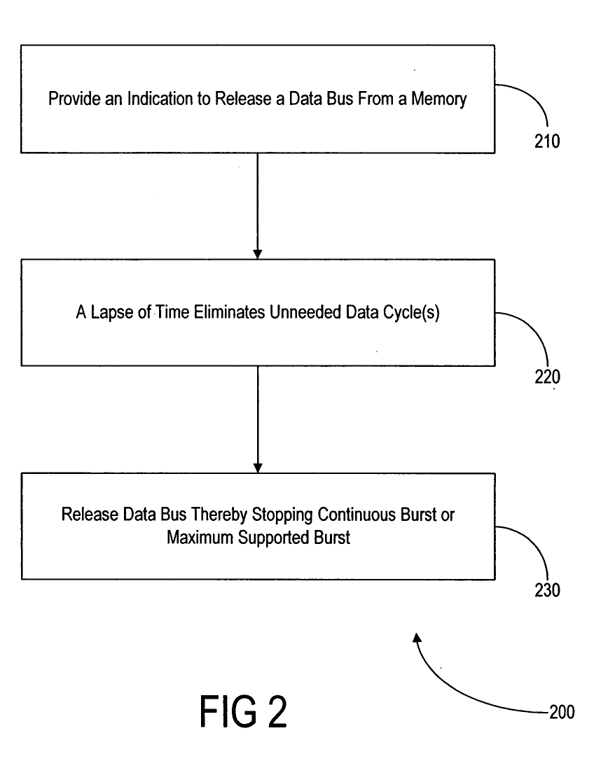

These four implementations have certain features in common, as shown in the flow chart 200 of FIG. 2. An indication is provided 210 to release a data bus from a memory. Then a lapse of time is utilized 220 to eliminate unneeded data cycles. Finally, the data bus is released 230 thereby stopping a continuous burst or a maximum supported burst.

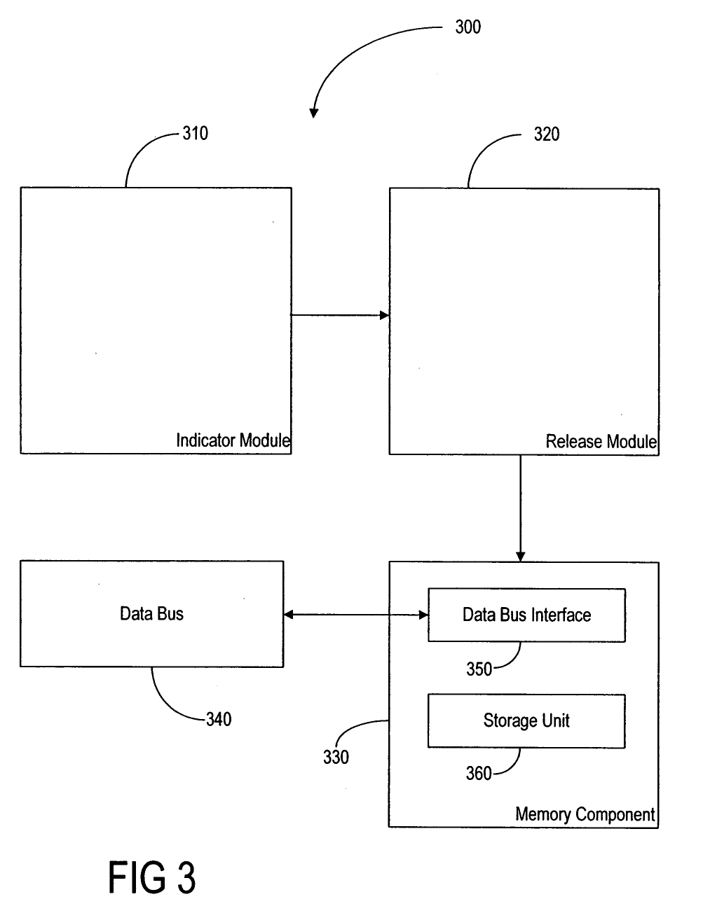

Turning now to the system 300 of FIG. 3, an indicator module 310 is configured to provide an indication to release a data bus 340 from a memory component 330. A release module 320 is configured to release the data bus in response to that indication, after delaying for a lapse of time. This system stops a continuous burst, or stops a maximum supported burst, that is used to read from or write to a storage unit 360 of the memory component 330, via the data bus interface 350. Stopping the burst after the lapse of time eliminates at least one unneeded data cycle, and therefore improves bus efficiency. Depending upon the implementation, there might be bubbles (empty data bus slots) in the data bus. Although an optimal design will reduce the amount of these bubbles, the primary achievement of the present invention is to free the data bus in an efficient manner.

The present invention can be implemented using a general purpose or specific-use computer system, with program code conforming to the method described herein. The program code is designed to drive the operation of the particular hardware of the system, and to be compatible with other system components and I/O controllers. The computer system of this embodiment may include a CPU processor, comprising a single processing unit, or multiple processing units capable of parallel operation, or the processor can be distributed across one or more processing units in one or more locations, e.g., on a client and server. The memory containing the memory component 330 may comprise any known type for data storage, including magnetic media, optical media, random access memory (RAM), read-only memory (ROM), a data cache, a data object, etc. Moreover, the memory may reside at a single physical location, comprising one or more types of data storage, or be distributed across a plurality of physical systems in various forms.

It is to be understood that the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method comprising:
providing an indication to release a data bus; and
releasing the data bus in response to the indication, after delaying for a lapse of time;
wherein the method stops a continuous burst, or stops a maximum supported burst, that is used to read from or write to a memory, and
wherein stopping the burst after the lapse of time eliminates at least one data cycle.

2. The method of claim 1, wherein needed data cycles do not include the at least one data cycle eliminated by stopping the burst.

3. The method of claim 2,
wherein the indication includes information about an amount of the needed data,
wherein the lapse of time is large enough so that the burst, which is a data burst, is stopped after the amount of the needed data is obtained.

4. The method of claim 2,
wherein the data burst is stopped by a burst stop command, or register write, or signal.

5. The method of claim 2,
wherein the indication includes a time by which the data bus must be released, and
wherein the lapse of time is small enough to occur before the time by which the data bus must be released.

6. The method of claim 2,
wherein the method is preceded by defining a magnitude of time, and storing the magnitude of time in a register,
wherein the lapse of time is less than or equal to the magnitude of time stored in the register.

7. The method of claim 2, further comprising:
recognizing when a counter starts at a first counter value and stops at a second counter value, and
calculating a number of the needed data cycles based at least partly upon the difference between the first counter value and the second counter value,
wherein the lapse of time is sufficient to attain the number of the needed data cycles.

8. The method of claim 5, further comprising:
calculating rising clock edges from a read or write command; and
determining therefrom a number of rising edges to be provided,
wherein the lapse of time is large enough to allow the number of rising edges to be provided.

9. A computer readable medium encoded with a software data structure for performing the method of claim 2.

10. The method of claim 2, wherein a signal is used to provide the indication, employing a fixed delay from logic or a fixed register value.

11. The method of claim 2, wherein a command or signal with a definable delay is used to provide the indication.

12. The method of claim 2, wherein a command or signal is used to provide the indication, using at least one formula that defines an amount of needed data.

13. A system comprising:
means for providing an indication to release a data bus; and
means for releasing the data bus in response to the indication, after delaying for a lapse of time,
wherein the system is for stopping a continuous burst, or stopping a maximum supported burst, that is used to read from or write to a memory, and
wherein stopping the burst after the lapse of time eliminates at least one data cycle.

14. The system of claim 13, wherein needed data cycles do not include the at least one data cycle eliminated by stopping the burst.

15. The system of claim 14,
wherein the indication includes information about an amount of the needed data,
wherein the lapse of time is large enough so that the burst, which is a data burst, is stopped after the amount of the needed data is obtained.

16. The system of claim 14,
wherein the indication includes a time by which the data bus must be released, and
wherein the lapse of time is small enough to occur before the time by which the data bus must be released.

17. The system of claim 14,
further comprising means for defining a magnitude of time, and storing the magnitude of time in a register,
wherein the lapse of time is less than or equal to the magnitude of time stored in the register.

18. The system of claim 14, further comprising:
means for recognizing when a counter starts at a first counter value and stops at a second counter value, and
means for calculating a number of the needed data cycles based at least partly upon the difference between the first counter value and the second counter value,
wherein the lapse of time is sufficient to attain the number of the needed data cycles.

19. A mobile device comprising the system of claim 13.

20. A software product comprising a computer readable medium having executable codes embedded therein; the codes, when executed, adapted for:
providing an indication to release a data bus; and
releasing the data bus in response to the indication, after delaying for a lapse of time;
wherein the method stops a continuous burst, or stops a maximum supported burst, that is used to read from or write to a memory, and
wherein stopping the burst after the lapse of time eliminates at least one data cycle.

21. The software product of claim 20, wherein the needed data cycles do not include the at least one data cycle eliminated by stopping the burst.

22. The software product of claim 21,
wherein the indication includes information about an amount of the needed data,
wherein the lapse of time is large enough so that the burst, which is a data burst, is stopped after the amount of the needed data is obtained.

23. The software product of claim 21,
wherein the indication includes a time by which the data bus must be released, and
wherein the lapse of time is small enough to occur before the time by which the data bus must be released.

24. A system comprising:
an indicator module configured to provide an indication to release a data bus; and
a release module configured to release the data bus in response to the indication, after delaying for a lapse of time,
wherein the system is for stopping a continuous burst, or stopping a maximum supported burst, that is used to read from or write to a memory, and
wherein stopping the burst after the lapse of time eliminates at least one data cycle.

25. The system of claim 24, wherein needed data cycles do not include the at least one data cycle eliminated by stopping the burst.

26. The system of claim 25,
wherein the indication includes information about an amount of the needed data,
wherein the lapse of time is large enough so that the burst, which is a data burst, is stopped after the amount of the needed data is obtained.

27. The system of claim 25,
wherein the indication includes a time by which the data bus must be released, and
wherein the lapse of time is small enough to occur before the time by which the data bus must be released.

28. The system of claim 25,
further comprising a timing module configured to define a magnitude of time, and store the magnitude of time in a register,
wherein the lapse of time is less than or equal to the magnitude of time stored in the register.

29. A mobile device comprising the system of claim 24.

30. A memory component comprising:
a storage unit for storing data; and
a data bus interface configured to support a burst for reading from or writing to the storage unit;
wherein the data bus interface is releasable on a delayed basis, to stop the burst, and
wherein stopping the burst after the lapse of time eliminates at least one data cycle.

31. The memory component of claim 30, wherein needed data cycles do not include the at least one data cycle eliminated by stopping the burst.

32. The memory component of claim 30, wherein a signal is used to provide a release indication to the data bus interface, employing a fixed delay from logic or a fixed register value.

33. The memory component of claim 30, wherein a command or signal with a definable delay is used to provide a release indication to the data bus interface.

34. The memory component of claim 30, wherein a command or signal is used to provide a release indication to the data bus interface, using at least one formula that defines an amount of needed data.

35. The memory component of claim 31, wherein elimination of the at least one data cycle removes at least one empty data bus slot in the data bus.
